(19) United States
(12) Patent Application Publication
(10) Pub. No.: US 2010/0262290 A1
(43) Pub. Date: Oct. 14, 2010

(54) Data matching apparatus, data matching method and mobile robot

(75) Inventors: Dong-jo Kim, Yongin-si (KR); Yeon-ho Kim, Yongin-si (KR); Dong-ryeol Park, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Gyeonggi-do (KR)

(21) Appl. No.: 12/591,092

(22) Filed: Nov. 6, 2009

(30) Foreign Application Priority Data
Jan. 7, 2009 (KR) 10-2009-0001306

(51) Int. Cl. G05B 15/00; H04N 7/18

(52) U.S. Cl. 700/259; 348/135; 348/E07.091

(57) ABSTRACT

A three-dimensional data matching system is disclosed. Data matching is performed by merging distance information and image information. Therefore, matching accuracy is improved even if a sensor with relatively low sensitivity is used. Matching data generated as a result of matching range data and CAD data is projected onto an image captured by a camera, an effective edge is extracted from the image, and an error of the matching data is corrected based on the effective edge, thereby improving matching accuracy.

### CROSS-REFERENCE TO RELATED APPLICATIONS

This application claims the benefit under 35 U.S.C. §119(a) of Korean Patent Application No. 10-2009-0001306, filed on Jan. 7, 2009, the disclosure of which is incorporated herein in its entirety by reference.

### BACKGROUND

1. Field

One or more embodiments relate to a three-dimensional data matching technique that can be applied to/as a technique in which a robot processes information to recognize an ambient environment.

2. Description of the Related Art

The term robot has typically referred to human-shaped mechanical devices with hands, feet, and other parts that operate similarly to a human being. However, the use of this term has recently expanded to refer to automatic devices that autonomously perform tasks regardless of shape or form.

In particular, mobile robots are noted for their ability to perform tasks in extreme circumstances or risky places in place of a human being. Mobile robots for home use which autonomously move about a home to help with household affairs, such as cleaning robots, have also recently come into wide use.

In order for a manufacturing robot to perform tasks while autonomously moving in a specific space, a technique of recognizing an ambient environment may be necessary. Using the technique of recognizing an ambient environment, a robot may continuously acquire and process information of an ambient environment while performing tasks.

A data matching technique is representative of a technique of processing acquired information to recognize an ambient environment. The data matching technique refers to a technique of comparing computer aided design (CAD) data of an observation object with information acquired through a sensor to recognize a shape and a position of an observation object.

In order for a robot to accurately recognize an ambient environment and actively cope with the appearance of an obstacle, data matching accuracy has to be high, and in order to improve data matching accuracy, a sensor of high sensitivity has been required.

However, a sensor of high sensitivity has a problem in that it is high in price and the corresponding light receiver would need to be large in size due to an optical characteristic, leading to a large-scaled system. Therefore, it is difficult to mount the sensor in a narrow area such as an arm of a robot. On the other hand, a sensor of low sensitivity is low in price and small in size, but has a problem in that matching accuracy is low since errors are included in acquired information.

### SUMMARY

One or more of the embodiments relate to a data matching apparatus, a data matching method, and a mobile robot in which matching accuracy is improved by correcting a data matching error using additional information in addition to distance information acquired through a sensor.

According to one or more embodiments, there is provided a data matching apparatus, including a camera and a data processing unit. The camera acquires image information. The data processing unit matches range data acquired by a distance sensor and stored computer aided design (CAD) data and corrects for a matching error using the image information.

The data processing unit may include a matching unit which matches the range data and the CAD data to generate matching data, an edge extracting unit which extracts an effective edge corresponding to a portion in which the range data and the CAD data are not matched together from the image information, and an error correcting unit which corrects the matching data to reduce or remove the matching error using the effective edge of the image information.

The data processing unit may further include a projecting unit which projects the matching data onto the image information. The data processing unit may further include a threshold value computing unit which computes a threshold value, with regard to determination of the matching error, for extracting the effective edge.

According to one or more embodiments, there is provided a mobile robot, including a camera, a data processing unit, and a robot controller. The camera acquires image information. The data processing unit matches range data acquired by a distance sensor and stored CAD data and corrects for a matching error using the image information, and the robot controller controls the mobile robot based on a result of the matching and correcting for the matching error.

According to one or more embodiments, there is provided a data matching method, including acquiring image information, matching range data acquired by a distance sensor and stored CAD data to generate matching data, extracting an effective edge corresponding to a portion of the image information in which the range data and the CAD data are not matched together for correcting for a matching error, and correcting the matching data to reduce or remove the matching error using the effective edge of the image information.

The data matching method may further include projecting the matching data onto the image information, and/or computing a threshold value, with regard to determination of the matching error, for computing the effective edge.

The matching data may include at least one of a feature line of CAD data and a feature line of the range data.

The threshold value may be computed based on a brightness of the image information.

The correcting of the matching data may include mapping the effective edge and the matching data in a same coordinate system and correcting the matching data so that the corrected matching data is identical to the effective edge.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a data matching apparatus according to an exemplary embodiment;

FIG. 2 is a block diagram of a data processing unit according to an exemplary embodiment;

FIG. 3 illustrates a data matching process according to an exemplary embodiment;

FIG. 4 illustrates image information according to an exemplary embodiment;

FIG. 5 illustrates a projection process according to an exemplary embodiment;

FIG. 6 illustrates an effective edge extracting process according to an exemplary embodiment;

FIG. 7 illustrates an error correction process according to an exemplary embodiment;

FIG. 8 is a flowchart illustrating a data matching method according to an exemplary embodiment; and

FIG. 9 illustrates a mobile robot according to an exemplary embodiment.

### DETAILED DESCRIPTION OF EMBODIMENTS

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

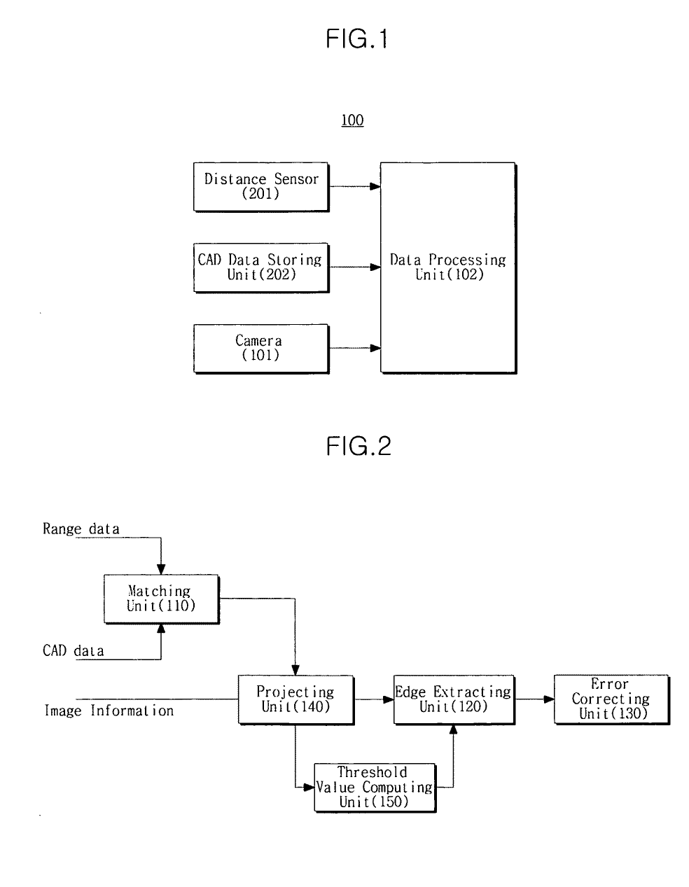

FIG. 1 is a block diagram of a data matching apparatus 100 according to an exemplary embodiment.

Referring to FIG. 1, the data matching apparatus 100 includes a camera 101 and a data processing unit 203 and may further include a distance sensor 201 and a computer aided design (CAD) data storing unit 202.

The camera 101 captures image information of an ambient area or environment.

To this end, the camera 101 may include an image sensor (for example, CCD-type or CMOS-type) which converts detected light into an electrical signal and an image processing module which receives an output of the image sensor and performs image processing on it.

The data processing unit 203 matches range data acquired from the distance sensor 201 and CAD data stored in the CAD data storing unit 202 and corrects an error occurring during data matching using image information acquired from the camera 101.

Here, “match” or “matching” refers to a process of comparing range data with CAD data to find values which are identical, e.g., sufficiently/substantially identical, to each other and recognizing an accurate shape or position of an observation object. That is, range data and CAD data may be shape information or position information of a particular observation object.

For example, when the data matching apparatus 100 is part of a welding robot which performs a welding task while moving in a specific area, the distance sensor 201 may detect a work space or a welding object to acquire three-dimensional range data, and the CAD data storing unit 202 may store CAD data for the work space or the welding object. The data processing unit 203 may match range data and CAD data to recognize a shape or a position of the work space or the welding object.

If information acquired from an ambient area or environment has no error at all, the ambient environment can be perfectly recognized through only matching of range data and CAD data, but sensing data commonly has an error, and thus an error may occur during matching.

The data processing unit 203 may correct an error which may occur during matching of three-dimensional range data and CAD data using supplementary image information acquired from the camera 101.

A data matching process and an error correction process which are performed through the data processing unit will be described below in further detail.

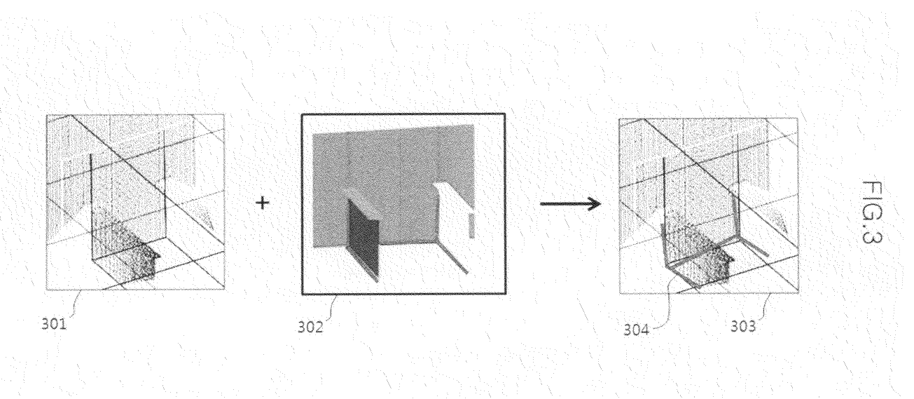

FIG. 2 is a block diagram of the data processing unit according to an exemplary embodiment.

Referring to FIG. 2, the data processing unit 203 may include a matching unit 110, an edge extracting unit 120, and an error correcting unit 130, and may further include a projecting unit 140 and a threshold value computing unit 150.

The matching unit 110 receives range data acquired from the distance sensor 201 and CAD data stored in the CAD data storing unit 202 and matches range data and CAD data to generate matching data.

For example, the matching unit 110 extracts planes from range data or CAD data and extracts a line or an edge in which the planes meet to match points on each line or edge. Here, an iterative closest point (ICP) algorithm may be used as a matching algorithm.

Since information acquired from the distance sensor 201 has an error component, a matching error occurring portion, that is, a portion in which a matching error occurs, may be included in matching data which is generated as a matching result of range data and CAD data as described above. For example, the matching data may be a feature line of CAD data which corresponds to a portion which does not match with range data.

The projecting unit 140 projects the matching data onto the image information acquired from the camera 101. Since the image information is commonly two-dimensional information and the range data or the CAD data is three-dimensional information, the projecting unit 140 may convert three-dimensional information to two-dimensional information.

The image information may be an image acquired from the camera 101 or feature information of the image. When the camera 101 and the distance sensor 201 share a coordinate system or observe the same object at locations adjacent to each other, the projecting unit 140 may project a feature line of the CAD data onto a predetermined area of an image corresponding to the feature line.

The edge extracting unit 120 extracts an effective edge from the image information. The effective edge may be a predetermined area of image information corresponding to a portion in which a matching error occurs that is present in the matching data. The threshold value computing unit 150 computes a threshold value for extracting the effective edge and provides it to the edge extracting unit 120.

Since the image information is acquired from the camera which detects light, the image information is information sensitive to light. That is, an image captured by the camera 101 may have a particular portion which is too dark or too bright depending on an ambient light source state. In the exemplary embodiment, matching is performed for points on a line or an edge in which planes meet, and an area around such a line or such an edge is frequently captured too darkly or too brightly. Therefore, in order to accurately detect an edge in the image information, the threshold value computing unit 150 computes a different threshold value depending on each area of an image and provides it to the edge extracting unit 120. A specific area for providing a threshold value may be a specific area of an image corresponding to a matching error occurring portion which is presented in the matching data, which can be understood through the fact that the matching data is projected onto the image information through the projecting unit 140.

The error correcting unit 130 corrects the matching data to reduce an error between the effective edge and the matching data.

For example, the error correcting unit 130 may map the effective edge and the matching data in the same coordinate system and correct a rotation value and/or a translation value of the matching data so that the matching data can be identical to the effective edge.

FIG. 3 illustrates one example of the matching data generated by the matching unit 110.

In FIG. 3, range data 301 is acquired from the distance sensor 201, and based on CAD data 302 stored in the CAD data storing unit 202, the matching data 303 can be derived.

The range data 301 and the CAD data 302 may be three-dimensional image information for the same object (for example, a welding object or obstacle), and the matching data 303 may be generated by mapping points of a line or an edge in which planes meet in each image in the same coordinate system.

It can be understood that the matching data 303 has a matching error. In the exemplary embodiment, the matching data 303 may include a feature line 304 corresponding to a portion in which a matching error occurs.

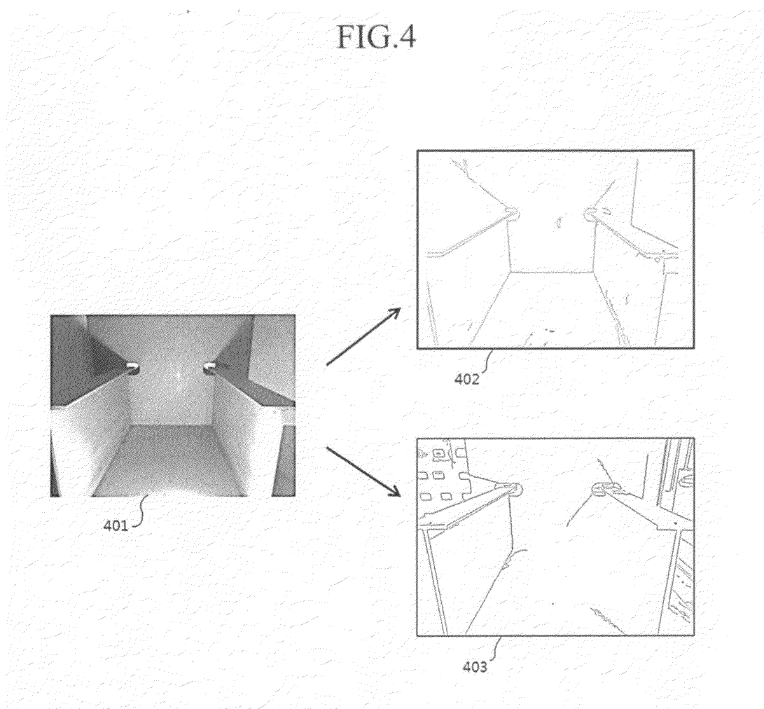

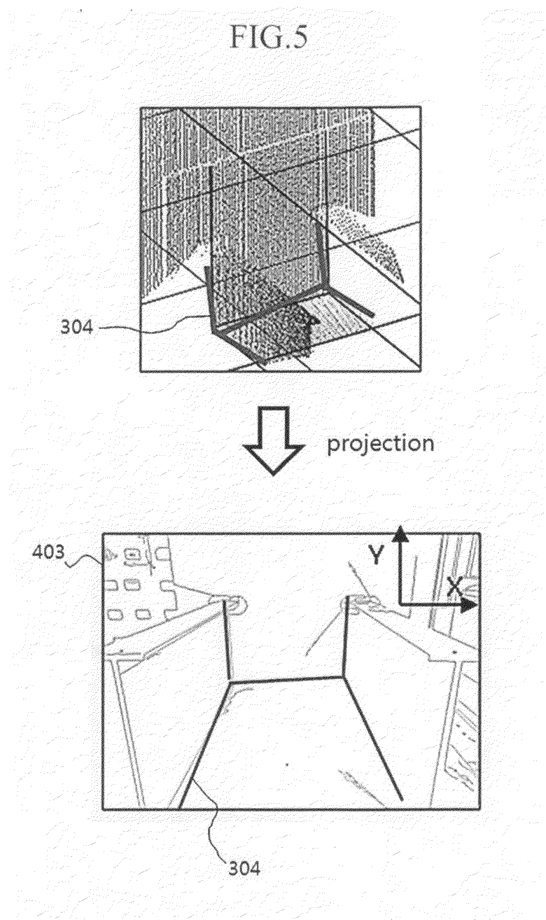

FIG. 4 illustrates an example of image information acquired from the camera 101.

In FIG. 4, an image 401 is captured by the camera 101, and feature information images 402 and 403 can be extracted from the image captured by the camera 101. For example, such images 402 or 403 may be output by extracting feature information through an image processing module installed in the camera 101.

The feature information may be a line or an edge in which planes meet in the image 401. All edges of the image 401 can be detected, as shown in the image 402, but a particular edge may not be detected, as shown in the image 403, e.g., due to an ambient light source state or a structural characteristic of a photographing object. For matching, it is desired that image 403 should be similar to image information obtained through the camera 101.

FIG. 5 illustrates an example in which a feature line (for example, feature line 304) of the matching data is projected onto image information (for example, image 403) through the projecting unit 140.

The projecting unit 140 may convert the feature line 304 of the matching data into coordinate values of the camera 101 and project the coordinate values onto the image 403. As described above, if it is assumed that the image 403 and the feature line 304 of the matching data are acquired for the same object, when the camera 101 and the distance sensor 201 share a coordinate system or observe the same object at locations adjacent to each other, a particular area of a three-dimensional image may be projected onto a particular area corresponding to a two-dimensional image.

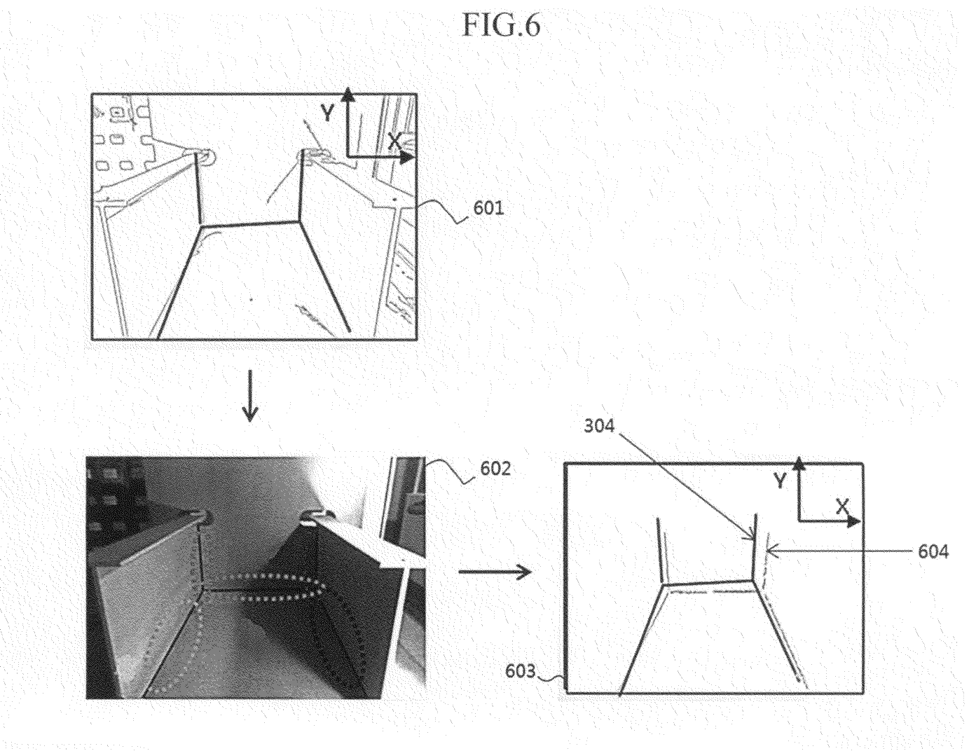

FIG. 6 illustrates an example of a method of extracting an effective edge from the image information through the threshold value computing unit 150 and the edge extracting unit 120.

In FIG. 6, the shown projection image 601 is generated through the projecting unit 140, with image information 602 denoting particular areas designated to compute respective threshold values and image information 603 denoting an effective edge extraction result.

It can be understood from the projection image 601 that image information which is not accurately detected is present around the feature line 304 of the matching data. This may occur when a single parameter is applied to extract feature information from an image of the camera 101 or areas differ in brightness information from each other.

The threshold value computing unit 150 may designate particular areas in the image information and compute a threshold value for each area as in the image information 602 in order to extract the effective edge. Here, the particular area may be designated around the matching data with reference to the projection image 601, and a threshold value may be computed based on brightness information. For example, a threshold value of a dark area may be set relatively lower than a threshold value of a bright area.

The edge extracting unit 120 extracts an effective edge such as effective edge 604 using the threshold value. The effective edge 604 may be an edge of image information corresponding to the feature line 304 of the matching data. The feature line 304 of the matching data may be a feature line of CAD data or range data.

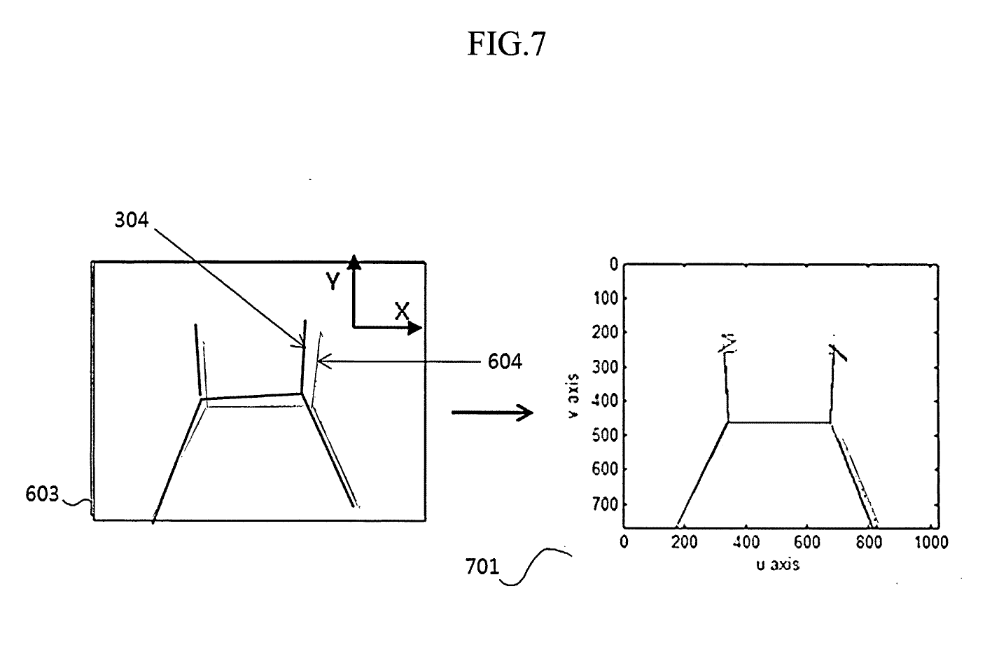

FIG. 7 illustrates an example of an error correction result performed through the error correcting unit 130.

In FIG. 7, feature line 304 denotes matching data in image information 603, effective edge 604 denotes an effective edge, and image information 701 denotes an error correction result.

The error correcting unit 130 may change each data value of the feature line 304 of the matching data based on the effective edge 604. For example, the error correcting unit 130 maps the effective edge 604 and the feature line 304 of the matching data in the same coordinate system, such as in image information 701, and performs correction so that the feature line 304 of the matching data can be identical to the effective edge 604.

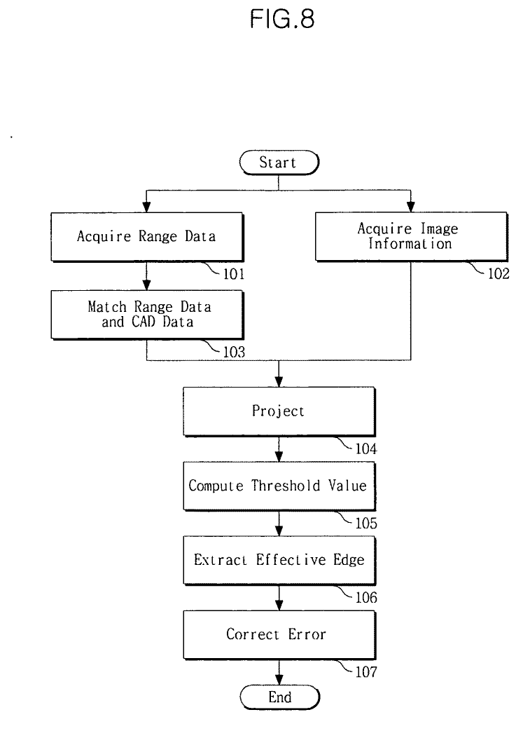

FIG. 8 is a flowchart illustrating a data matching method according to an exemplary embodiment.

First, range data and image information for the same object are acquired (operations 102 and 108). For example, the range data may be acquired by scanning the object using infrared rays through the distance sensor 201, and image information may be acquired by capturing the same object through the camera 101.

Then, matching data is generated by matching the range data and the CAD data (operation 103). For example, the matching unit 110 may match the range data 301 and the CAD data 302 to generate the matching data, e.g., matching data 303 or feature line 304, as illustrated in FIG. 3. The CAD data 302 may be three-dimensional image information of an object observed by the distance sensor 201 and the camera 101, and the three-dimensional image information is stored in the CAD data storing unit 202.

Next, the matching data is projected onto the image information (operation 104), and thus a projection image such as an image of FIG. 5 is generated through the projecting unit 140.

Subsequently, a threshold value is computed with reference to the projection image (operation 105). For example, the threshold value computing unit 150 may designate particular areas in the image information 602 and compute a threshold value for each area as illustrated in FIG. 6. The designated particular area may be an area around an area in which a matching error occurs, and a threshold value of each area may be individually set based on brightness information.

Then, an effective edge is extracted from the image information (operation 106). For example, the edge extracting unit 120 may extract the effective edge using the threshold value as illustrated in FIG. 6. The effective edge may be an edge of image information corresponding to a matching error occurring portion which is present in the matching data.

Then, the matching data is corrected for to reduce an error between the effective edge and the matching data (operation 107). For example, the error correcting unit 130 may compute an error value between the feature line 304 of the matching data and the effective edge 604 and may repetitively compute the error value while correcting each data value of the matching data until the error value becomes a value equal to or less than a predetermined threshold value as illustrated in FIG. 7.

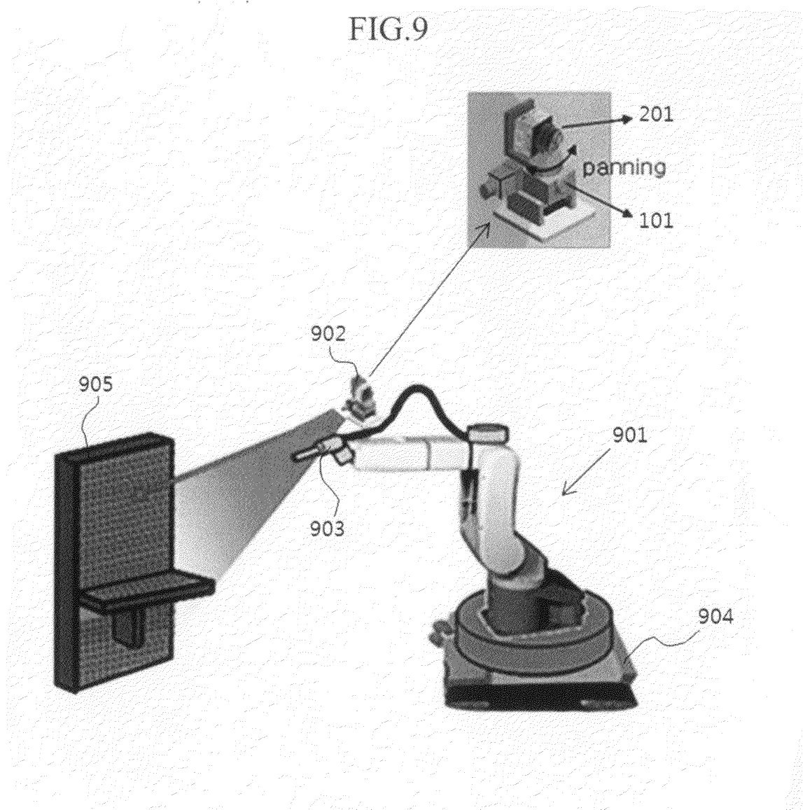

FIG. 9 illustrates a mobile robot according to an exemplary embodiment.

Referring to FIG. 9, the mobile robot 901 according to an exemplary embodiment may be a welding robot which performs a welding task while moving in a particular space.

In order for the robot 901 to perform an accurate welding task in a work space, a shape or a position of a welding object 905 or appearance of an obstacle should be accurately recognized, and thus the data matching apparatus 100 according to an exemplary embodiment may be mounted in the robot 901. The robot 901 may further include a robot controller. The robot controller may recognize an ambient environment based on a matching result and transfer a work instruction to a welding unit 903 or a driving unit 904 of the robot 901.

The welding unit 903 receives a work instruction from the robot controller to perform a welding task for the welding object 905. A sensor module 902 in which the camera 101 and the distance sensor 201 of the data matching apparatus 100 are integrated may be installed around the welding unit 903. Therefore, range data and image data of the welding object 905 may be simultaneously acquired through the sensor module 902.

As apparent from the above description, according to exemplary embodiments, since CAD data matching is performed by merging image information and range information, matching accuracy is improved.

In addition to the above described embodiments, embodiments can also be implemented through computer readable code/instructions in/on a medium, e.g., a computer readable medium, to control at least one processing device to implement any above described embodiment. The medium can correspond to any defined, measurable, and tangible structure permitting the storing and/or transmission of the computer readable code.

The computer readable media may also include, e.g., in combination with the computer readable code, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of computer readable code include both machine code, such as produced by a compiler, and files containing higher level code that may be executed by the computer using an interpreter, for example. The media may also be a distributed network, so that the computer readable code is stored and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A data matching apparatus, comprising:
a camera which acquires image information; and
a data processing unit which matches range data acquired by a distance sensor and stored CAD data and corrects for a matching error using the image information.

2. The data matching apparatus of claim 1, wherein the data processing unit comprises:
a matching unit which matches the range data and the CAD data to generate matching data;
an edge extracting unit which extracts an effective edge corresponding to a portion in which the range data and the CAD data are not matched together from the image information; and
an error correcting unit which corrects the matching data to reduce or remove the matching error using the effective edge of the image information.

3. The data matching apparatus of claim 2, wherein the matching data comprises at least one of a feature line of CAD data and a feature line of the range data.

4. The data matching apparatus of claim 2, wherein the error correcting unit maps the effective edge and the matching data in a same coordinate system and corrects the matching data so that the corrected matching data is identical to the effective edge.

5. The data matching apparatus of claim 2, wherein the data processing unit further includes a projecting unit which projects the matching data onto the image information.

6. The data matching apparatus of claim 2, wherein the data processing unit further includes a threshold value computing unit which computes a threshold value, with regard to determination of the matching error, for extracting the effective edge.

7. The data matching apparatus of claim 6, wherein the threshold value computing unit computes the threshold value based on a brightness of the image information.

8. A mobile robot, comprising:
a camera which acquires image information;
a data processing unit which matches range data acquired by a distance sensor and stored CAD data and corrects for a matching error using the image information; and
a robot controller which controls the mobile robot based on a result of the matching and correcting for the matching error.

9. The mobile robot of claim 8, further comprising, a welding unit which receives the work instruction of the robot controller, based on the matching data, and is configurable to weld an object based on the work instruction.

10. The mobile robot of claim 9, wherein the camera is mounted onto the welding unit to photograph the object, and the CAD data includes three-dimensional data for the object.

11. A data matching method, comprising:
acquiring image information;
matching range data acquired by a distance sensor and stored CAD data to generate matching data;
extracting an effective edge corresponding to a portion of the image information in which the range data and the CAD data are not matched together for correcting for a matching error; and
correcting the matching data to reduce or remove the matching error using the effective edge of the image information.

12. The data matching method of claim 11, wherein the matching data includes a feature line of CAD data corresponding to the portion of the image information which does not match with the range data.

13. The data matching method of claim 11, wherein the correcting of the matching data comprises mapping the effective edge and the matching data in a same coordinate system and correcting the matching data so that the corrected matching data is identical to the effective edge.

14. The data matching method of claim 11, further comprising projecting the matching data onto the image information.

15. The data matching method of claim 11, further comprising computing a threshold value, with regard to determination of the matching error, for computing the effective edge.

16. The data matching method of claim 15, wherein the threshold value is computed based on a brightness of the image information.
